(19) United States
(12) Patent Application Publication
(10) Pub. No.: US 2026/0161893 A1
(43) Pub. Date: Jun. 11, 2026

(54) ADAPTING OUTPUTS OF GENERATIVE MODELS

(71) Applicant: GOOGLE LLC, Mountain View, CA (US)

(72) Inventors: Florian Nils Hartmann, Zurich (CH); Matthew Sharifi, Kilchberg (CH)

(21) Appl. No.: 18/973,906

(22) Filed: Dec. 9, 2024

(51) Int. Cl. G06F 40/284

(52) U.S. Cl. CPC G06F 40/284

(57) ABSTRACT

Implementations disclose utilizing a second generative model to generate information for adapting a provisional output that has been generated by a first generative model. Those implementations are further directed to then adapt the provisional output based on the information generated by the second generative model. In some implementations, the first generative model is executed at a first device and the second generative model is executed at a second device. In other implementations, the first generative model and the second generative model are executed at the same device.

### BACKGROUND

Various generative models have been proposed that can be used to process natural language (NL) content and/or other input(s), to generate output that reflects generative content that is responsive to the input(s). As one example, large language models (LLM(s)) have been developed that can be used to process NL content and/or other input(s), to generate LLM output that reflects generative NL content and/or other generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”.

Also, so-called assistant LLMs have been developed that can perform various tasks responsive to input(s) from a user. Some tasks can involve the assistant LLM producing generative output on behalf of the user. For instance, a user can request the assistant LLM to automatically compose content on their behalf, e.g. by providing the NL input “tell my partner that I'm running late”. In this scenario, the assistant LLM can process the NL content “tell my partner that I'm running late” to generate content that is responsive to the input. For instance, responsive to this input the assistance LLM can generate LLM output in the form of a communication (e.g., a short message service, SMS, message, a multimedia message, an email, or so on) to be sent to a particular recipient, in this case, the user's partner.

The output that is generated using a generative model is a sequence of probability distributions. For example, the output that is generated using a neural machine translator (NMT) or an LLM can be a sequence of probability distributions over a vocabulary, such as a vocabulary of words, word pieces, and/or other token(s). However, the assistant LLM may have been trained to generate output in a style (e.g., a writing or speaking style) that is different to that of the user. As a result, when the assistant LLM is tasked with generating output on behalf of the user, the output that is generated may not match the user's usual style. For example, this could lead to the generative content being misinterpreted by a recipient of a message including the content (e.g., the user's partner in the above example).

### SUMMARY

Implementations disclosed herein are directed to providing input to a first generative model (GM) (e.g., a language model such as a large language model (LLM)) to generate provisional output responsive to the input. Those implementations are further directed to providing at least part of the provisional output to a second GM (e.g., a language model, LM), to generate information which is then used by the first GM to adapt the provisional output. This approach can result in improved generative content. By providing at least part of the provisional output to the second GM, and subsequently adapting the provisional output based on information generated by the second GM, at least part of (e.g., a part or a whole of) the provisional output can be adapted according to a different style (e.g., a different writing or speaking style) compared to a style in which the first GM has been trained to generate output. In this way, generative output that has been generated by the first GM and adapted based on information generated by the second GM may more accurately reflect the intended style for the output. For instance, a user may not have to edit the adapted output, or may only have to make fewer changes, compared to systems that produce generative content that is less adapted to the style that is required. Accordingly, fewer computing resources may be consumed in the process of providing user input, for example when a user tasks the first GM with generative content on their behalf but then subsequently has to edit (e.g., wholly or substantially rewrite) the generated content to achieve the desired result.

In various implementations, a second GM (e.g., a user LM) can be used to adapt provisional output that has been generated by a first GM (e.g., an automated assistant LLM) responsive to certain input. The first GM, such as an automated assistant LLM, can be a relatively large model compared to the second GM (e.g., a user LM). Some non-limiting examples of automated assistant GMs include, but are not limited to, Gemini Nano on Android and Chrome. The second GM that is used to generate information for adapting the provisional output generated by a first GM can include a model that has been trained (e.g., fine-tuned) for a user's particular style in relation to the type of output being generated (e.g., a user's writing and/or speaking style, in the case of a LM). Some non-limiting examples of user GMs, which are smaller (e.g., in terms of a number of layers/nodes/connections included in the model) and consume fewer computing resources compared to automated assistant GMs, include (but are not limited to) the Gboard LM for predicting text in a mobile keyboard interface. Since the second GM (e.g., a user LM) consumes fewer computing resources when executed, in some implementations the second GM can be executed continuously at a second device (e.g. executed continuously while a user is typing at a client device).

For instance, as a non-limiting example, assume a scenario in which the user requests a first GM (e.g., an assistant LLM running on a server or locally at a client device) to automatically compose content on their behalf, by providing the NL input “tell my partner that I'm running late”. In various implementations of the present disclosure, in this scenario the assistant LLM can process the NL content “tell my partner that I'm running late” to generate provisional output that is responsive to the input, and in doing so can utilize the reasoning capabilities of the assistant LLM. The second GM (e.g., a user LM running locally on the user's device) can then be used to produce information for adapting the provisional output, e.g. by accepting/rejecting/re-scoring tokens decoded by the first GM, to obtain adapted output that more closely matches the user's own style.

However, it should be understood that, in various implementations, techniques described herein may selectively utilize the second GM. For instance, in the above example, the second GM may be utilized since the user request involves the assistant LLM generating a message on behalf of the user. However, in other example, the second GM may not be utilized, such as is instances where the user request asks the assistant LLM to generate text from a perspective other than that of the user (e.g., a summarization task, an information seeking task, an image generation task, and/or other tasks).

This approach offers a number of advantages compared to systems that only use a single GM (e.g., an automated assistant LLM) to generate output. By utilizing two separate models in this way, the second GM can be a comparatively small model, and as such can have very low latency (e.g., enabling the second GM to generate output quickly when required, such as suggesting words as the user types, in a predictive text use-case). Due to its small size, the second GM can be executed locally on a client device, where computing resources may be limited. On the other hand, the first GM (e.g., an automated assistant LLM) can be a larger model, and consequently can be capable of solving more complex tasks compared to the second GM. Due to its large size, the first GM may be executed on another device (e.g., a server), and can be queried by client devices as and when required. However, in some instances, the first GM can be executed locally at the client device. Also, by using the second GM to adapt the provisional output by the first GM, adapted output can be obtained that benefits from the capabilities of both the first and second GMs. For instance, the adapted output can benefit from the reasoning capabilities of the first GM, and can benefit from the fine-tuning of the second GM to produce output in the particular style of the user as and when needed (e.g., when the first GM is tasked with generating output in the style of the user).

In some implementations, the first GM may have been trained to generate output based on a first probability distribution, and the second GM may have been trained to generate output based on a second probability distribution different from the first probability distribution. As one non-limiting example of some implementations disclosed herein, assume that the first GM is an automated assistant generative model, such as an LLM, and the second GM is a user LM, for instance, a model that has been trained to generate output based on a second probability distribution that is indicative of a writing or speaking style associated with a user profile. By utilizing separate models, the first and second GMs can be trained (e.g., fine-tuned and/or re-trained) independently of one another. In this way, the separate and distinct output styles of both models can be preserved.

Also, as a hypothetical comparative example, if the first GM (e.g., an LLM) was fine-tuned based on training data from a single user to be able to generate content in that user's style, the reasoning capabilities of the GM may be compromised compared to a GM that has been trained on a much larger dataset. Hence, by keeping the first and second GMs separate, the second GM can be fine-tuned to a particular user's style without compromising the reasoning capabilities of the first GM.

As described herein, a generative model (GM) can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a simplified representation of the example environment of FIG. 1, according to various implementations.

FIG. 3 depicts a flowchart illustrating an example method of adapting an output of a first GM, according to various implementations.

FIG. 4 depicts a flowchart illustrating an example of the method of FIG. 3, in an implementation in which the first GM and the second GM are executed at separate devices.

FIG. 5 depicts a flowchart illustrating an example of the method of FIG. 3, in an implementation in which the first GM and the second GM are executed at separate devices.

FIG. 6 depicts a flowchart illustrating an example token-based method of adapting an output of a first GM, according to various implementations.

FIG. 7 depicts a flowchart illustrating an example token-based method of adapting an output of a first GM, in which a second GM can generate an end-of-sequence token to cause a sequence in the adapted output to be terminated, according to various implementations.

FIG. 8 depicts an example architecture of a computing device, in accordance with various implementations.

### DETAILED DESCRIPTION

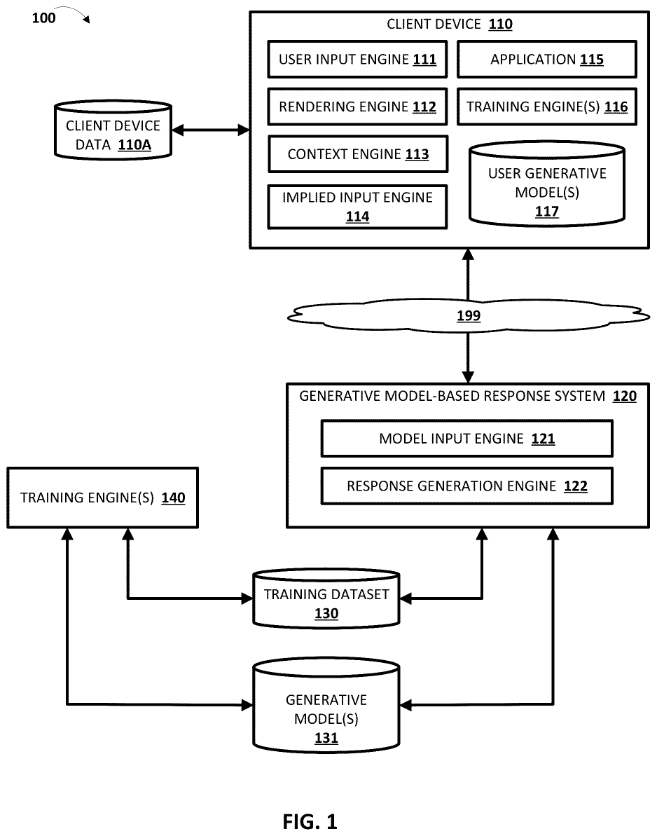

Turning now to FIG. 1, a block diagram of an example environment 100 that demonstrates various aspects of the present disclosure, and in which implementations disclosed herein can be implemented is depicted. The example environment 100 includes a client device 110, a generative model-based response system 120, and training engine(s) 140. Although illustrated separately, in some implementations all or aspects of generative model-based response system 120 and all or aspects of the training engine(s) 140 can be implemented as part of a cohesive system.

In some implementations, all or aspects of the generative model-based response system 120 can be implemented locally at the client device 110. In additional or alternative implementations, all or aspects of the generative model-based response system 120 can be implemented remotely from the client device 110 as depicted in FIG. 1 (e.g., at remote server(s)). In those implementations, the client device 110 and the generative model-based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which input data can be provided and/or selected, and/or other response(s) to the input data can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the generative model-based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of input data described herein can be input data that is formulated based on user input provided by a user of the client device 110 and detected via user input engine 111. For example, a query can be typed via a physical or virtual keyboard, a suggested query that is selected via a touch screen or a mouse, a spoken voice query that is detected via microphone(s) of the client device, or an image query that is based on an image captured by a vision component of the client device or an image stored in a memory of the client device.

In various implementations, the client device 110 can include a rendering engine 112 that is configured to provide content (e.g., generative content) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing client device data 110A. For example, the client device data 110A may be indicative of current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided).

In various implementations, the client device 110 can include one or more training engines 116 and one or more GMs 117 (e.g., one or more user GMs such as user LMs). In various implementations, some, all, or none of the training engine(s) 116 and/or some, all, or none of the user LM(s) 117 can be stored and/or executed remotely from the client device 110. In such implementations, the client device 110 can be communicatively coupled to the remote training engine(s) 116 and/or the remote user LM(s) 117. The one or more training engines 116 can be used to train (e.g., fine-tune) the one or more GMs 117 to be able to generate output that more accurately matches the user's own style.

The user GM(s) 117 can, for example, be trained by the training engine(s) 116 to generate output (e.g. in the form of text) in a style of a user of the client device 110. For instance, the user GM(s) 117 can include a plurality of user GMs 117 each associated with a respective user profile. In such implementations, the user GM 117 associated with a respective user profile (e.g., an active user of the client device 110) can be used to generate output in the style of that particular user. For instance, the one or more training engines 116 may train the one or more user GMs 117 based on client device data 110A that includes historical data about user input (e.g., input in the form of text or speech) received via the user input engine 111 during previous interactions between the user and the client device 110.

In some implementations, the user GM(s) 117 can include a plurality of user GMs 117 associated with a single user (e.g., associated with the same user profile). For instance, one user GM 117 associated with a particular user can be trained to generate output in a first style associated with a specific context (e.g., corresponding with work colleagues), whereas another user GM 117 associated with the same user can be trained to generate output in a second style associated with a different context (e.g., corresponding with friends or family).

The user GM(s) 117 may be utilized by the client device 110 in various use cases. For example, in some implementations, the client device 110 may utilize one of the user GM(s) 117 to provide a predictive text function, for instance to provide next-word predictions while the user is providing input via the user input engine 111. As another example, in some implementations, the client device 110 may utilize one of the user GM(s) 117 for disambiguation in a speech recognition system (e.g., when using the user input engine 111 to perform speech-to-text translation). As such, the output of the user GM(s) 117 may take different forms depending on the function that is being performed by the user GM(s) 117, and optionally based on an input provided by a user of the client device 110, a context of the user of the client device 110, and/or a context of the client device 110.

Further, the client device 110 and/or the generative model-based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

The generative model-based response system 120 is illustrated as including a model input engine 121, and a response generation engine 122. Some of the engines can be omitted in various implementations. In some implementations, the engines of the generative model-based response system 120 are distributed across one or more computing systems.

The model input engine 121 can, in response to receiving a query/input data, generate model input that is to be processed using a generative model in generating a response to the query/input data. As described herein, such content can include query content that is based on the query and/or additional content, such as contextual information. The model input engine can, for example, reformat input data into a suitable form for input into a generative model, e.g., reformat an input NL query as a prompt for an LLM, reformat one or more input images into a tensor for input into an image generation model or the like.

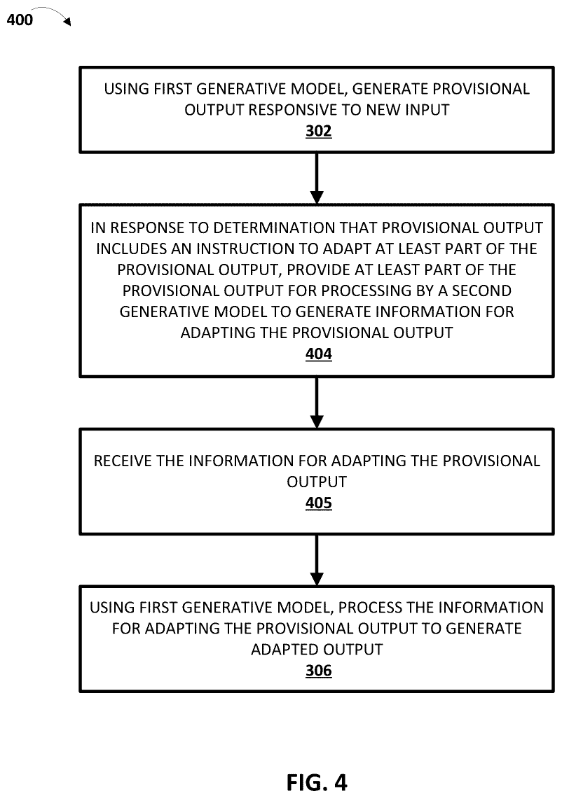

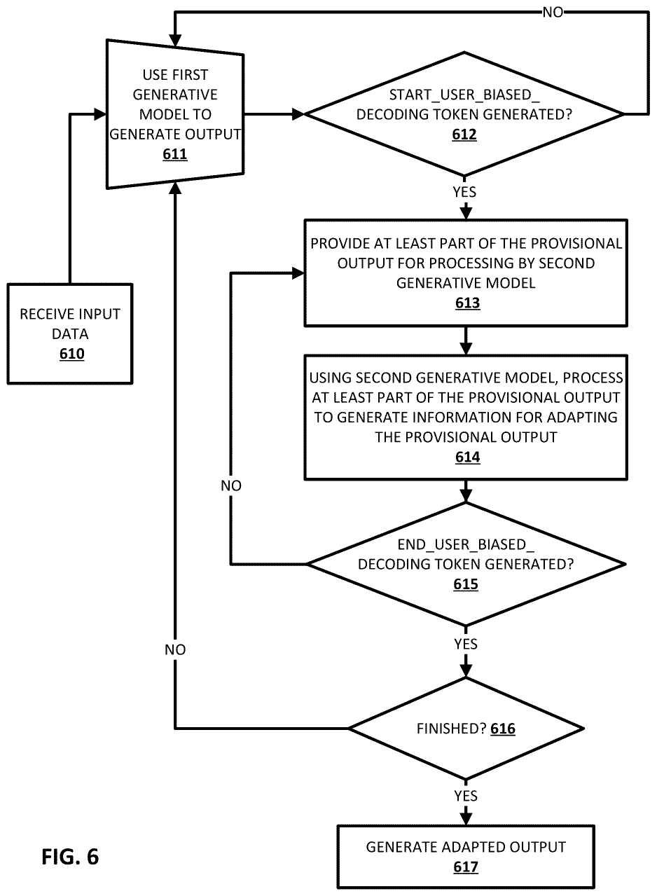

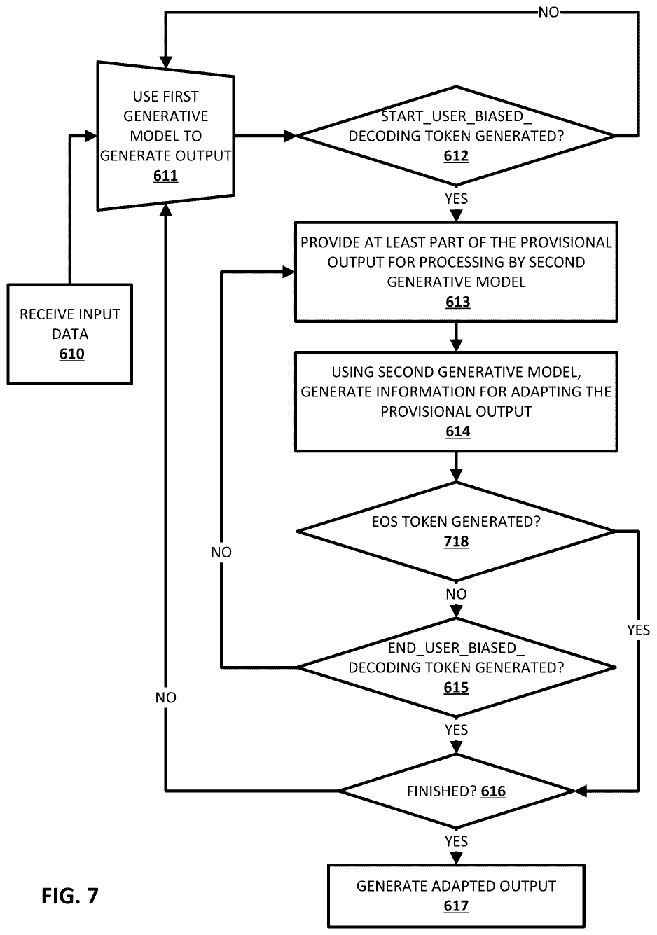

The response generation engine 122 can process input data that is generated by the model input engine 121 (e.g., using a generative model) to generate response/output data. The response generation engine 122 can generate one or more candidate responses from the input data/query using one or more generative models 131. Generating the one or more generative outputs from a respective set of input data can include generating one or more distributions over a set of potential generative outputs. Each generative output may be generated by sampling from this distribution, e.g., each generative output may correspond to a different decoding of a probability distribution generated using the respective model. In some implementations, a response selection engine (not shown) can select one or more of the candidate responses generated by the response generation engine 122 for presentation to the user, e.g., via the rendering engine 112 and/or application 115 of the client device 110. In various implementations, response generation engine 126 can perform all or aspects of, for example, blocks 302 and 306 of FIGS. 3 and 4, and/or blocks 611, 612, 615, and 615 of FIGS. 6 and 7.

In some implementations, the one or more user GMs 117 and/or the one or more GMs 131 can be pre-trained on large amounts of data including data from, but not limited to, webpages, electronic books, software code, electronic news articles, and machine translation data. For instance, training engine(s) 116, 140 can train and/or re-train the generative model(s) 131 based on a training dataset 130. The GMs 117, 131 can be pre-trained using unsupervised or self-supervised learning. For example, the GMs 117, 131 can be pre-trained on a next token prediction task and/or a masked token prediction task. The parameters of the machine-learned GMs 117, 131 can be frozen for subsequent processing. In this way, the capabilities of the machine-learned GMs 117, 131 (including the general purpose capabilities, or in other words, multi-domain capabilities, of the machine-learned GM 117, 131) will not be “forgotten” as a result of further training or fine-tuning.

The machine-learned GMs 117, 131 may, in some implementations, be a neural network model. For example, the machine-learned GMs 117, 131 may include one or more of: a convolutional neural network; a variational autoencoder; a recurrent neural network (RNN), such as a long short-term memory (LSTM) network; a transformer-based network; or the like. The machine-learned GMs 117, 131 may be a generative model trained using generative-adversarial techniques, such as a conditional GAN (cGAN). The machine-learned GMs 117, 131 may be a stable diffusion model. Many other examples are possible as noted herein.

In some implementations, the machine-learned GMs 117, 131 may be a large language model (LLM) configured to generate a sequence of text tokens from a set of input data. The input data includes a natural language prompt, e.g., a sequence of text tokens. The prompt may be a query or request for the LLM to provide some information, or to perform a function. For example, the input prompt may include the text “Can you summarize the plot to the play Hamlet”. Based on this prompt the LLM generates a plurality of textual summaries of the play Hamlet.

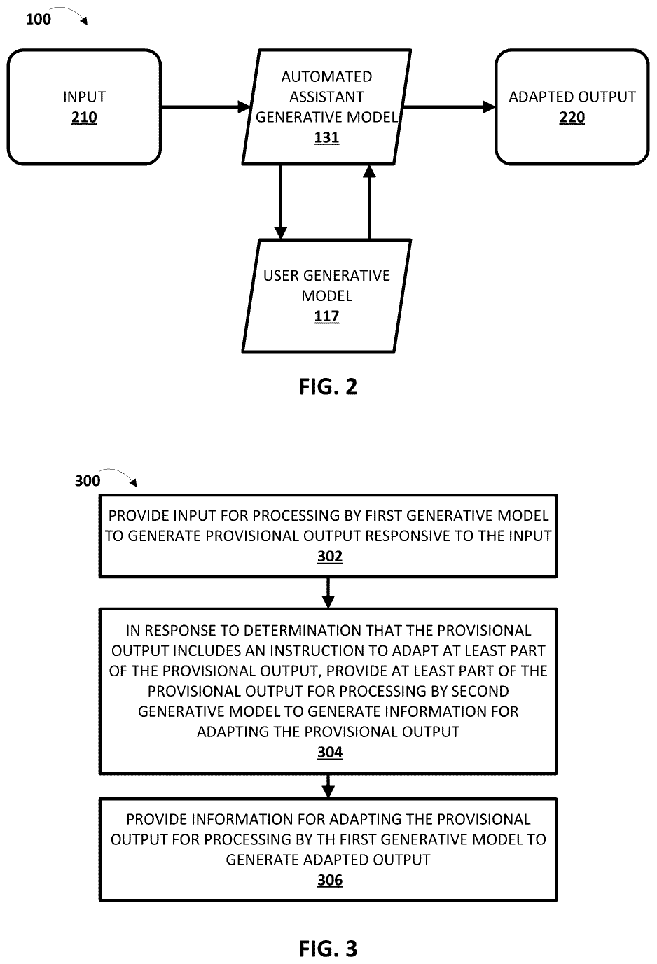

Turning now to FIG. 2, an overview of an example system 100 for adapting an output of a first language model, according to various implementations, is depicted. The system illustrated in FIG. 2 is a simplified representation of the system illustrated in FIG. 1, to assist in understanding of the present disclosure.

As illustrated in FIG. 2, input 210 is provided to a first machine-learned (or in other words, pre-trained) GM 131, e.g. an automated assistant GM 131. For instance, the input 210 can include input data that is generated by the model input engine 121 (e.g., using a generative model), as described above with reference to FIG. 1. In some implementations, the machine-learned GM 131 has already been pre-trained, and can be retrieved, for instance, from one or more machine-learned GMs (e.g., the GM(s) 131 of FIG. 1) from local or remote storage. Additionally, or alternatively, in some implementations, the machine-learned GM 131 can be generated based on pre-training (or further pre-training) a GM retrieved from local or remote storage.

In various implementations, the GM 131 (e.g. an automated assistant GM, such as an assistant LLM), which may be referred to as a first GM 131, is communicatively coupled to a second GM 117 (e.g. a user GM, such as a user LM). In some implementations, the first GM 131 has been trained to generate output based on a first probability distribution, and the second GM 117 has been trained to generate output based on a second probability distribution different to the first probability distribution. For instance, in some implementations where the second GM 117 is a user LM, the second probability distribution can be indicative of a writing or speaking style associated with a user profile (e.g., a user profile associated with the particular user LM 117, in implementations where a plurality of user LMs 117 are associated with respective user profiles).

The GM 131 can process the new input 210 to generate provisional output responsive to the input 210. As will be described in more detail below, the provisional output can include an instruction (e.g., one or more instructions) to adapt at least part of the provisional output. For instance, the instruction can take the form of a special token decoded by the GM 131 in the provisional output. Alternatively, or additionally, the instruction can be implemented using any suitable function or tool calling mechanism.

In response to a determination (e.g., a determination by the GM 131, or by another aspect of the system 100) that the provisional output includes an instruction to adapt at least part of the provisional output (e.g., one or more parts of the provisional output, or the whole of the provisional output), the GM 131 can communicate with the second GM 117 to provide the second GM 117 with at least part of the provisional output (e.g., the part of the provisional output that is to be adapted). The second GM 117 can process at least part of the provisional output to generate information for adapting the provisional output. The information generated by the second GM 117, in other words, the information for adapting the provisional output, can be provided to the first GM 131. The first GM 131 processes the information to generate adapted output 220.

In some implementations, the second GM 117 is one of a plurality of second GMs 117 and the user profile is one of a plurality of user profiles, each of the plurality of second GMs being associated with a respective one of the plurality of user profiles. In some of those implementations, the system 100 (e.g., the first GM 131) can select a respective one of the plurality of second GMs 117 as the second GM 117 to be used to generate information for adapting the provisional output generated by the first GM 131. The system 100 can make such a selection in dependence on the user profile associated with said respective one of the plurality of second GMs 117, thereby to adapt the at least part of the provisional output to the writing or speaking style associated with said user profile.

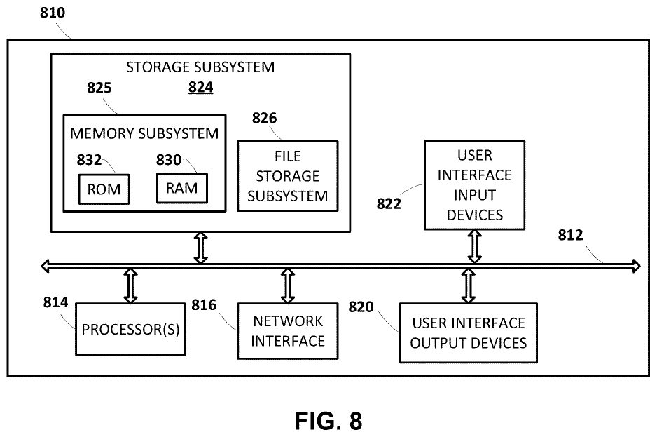

Turning now to FIG. 3, a flowchart illustrating an example method of adapting an output of a first GM (e.g., an LLM) is depicted. For convenience, the operations of the method 300 are described with reference to a system that performs the operations. This system of the method 300 includes at least one processor, memory, and/or other component(s) of computing device(s) (e.g., the client device 110 of FIG. 1, generative model-based response system 120 of FIG. 1, computing device 810 of FIG. 8, and/or other computing device.). Moreover, while operations of the method 300 are shown in a particular order, this is not meant to be limiting. One or more operations may be reordered, omitted, and/or added.

At block 302 of FIG. 3, the system provides input for processing by the first GM 131 to process input, to generate provisional output responsive to the input. As described above, the provisional output can include an instruction to adapt at least part of the provisional output.

At block 304 of FIG. 3, in response to a determination that the provisional output includes an instruction to adapt at least part of the provisional output, the system (e.g., the first GM 131) provides the at least part of the provisional output as input for processing by the second GM 117, to generate information for adapting the provisional output.

The provisional output can include a plurality of first tokens decoded by the first GM 131. In some implementations, the first GM 131 and the second GM 117 are configured to use the same tokenization scheme. For instance, the first GM 131 and second GM 117 can be configured to have matching token vocabularies. In some implementations, providing at least part of the provisional output for processing by the second GM 117 includes providing one or more of the plurality of first tokens decoded by the first GM 131 as input to the second GM 117. For instance, the one or more first tokens that are provided for processing by the second GM 117 can include respective top-k tokens generated by the first GM 131 (e.g., one or more top-k tokens included in the at least part of the provisional output that is to be adapted).

In some implementations in which one or more of the plurality of first tokens decoded by the first GM 131 are provided for processing by the second GM 117, the second GM 117 can generate information for adapting the provisional output that is indicative of whether each of the one or more first tokens is accepted or rejected. Additionally, or alternatively, the information for adapting the provisional output can be indicative of a new score and/or ranking assigned to at least one of the one or more first tokens by the second GM 117. For instance, in response to a first token being rejected by the second GM 117, the second GM 117 can generate information for adapting the provisional output that is indicative of a new score and/or ranking assigned to the rejected first token by the second GM 117. By assigning a new score and/or ranking to one or more first tokens, the provisional output can be biased by the second GM 117 (e.g., when the information for adapting the provisional output is processed by the first GM 131) to generate the adapted output.

In some implementations in which one or more first tokens is indicated as rejected in the information for adapting the provisional output, the information can include one or more second tokens to replace respective rejected tokens among the one or more first tokens. Here, the second tokens can be tokens that have been decoded by the second GM 117 when processing the provisional output.

In some implementations, providing at least part of the provisional output for processing by the second GM 117 in block 304 can include providing contextual information for processing by the second GM 117. The contextual information can be indicative of a context associated with the input 210 that was provided to the first GM 131. Providing the second GM 117 with contextual information can enable the provisional output to be adapted in a more suitable manner for the present context, e.g. by enabling the second GM 117 to generate information for adapting the provisional output that is better suited to the present context.

For instance, the contextual information may be indicative of whether the input 210 relates to a work context (e.g., a message to a work colleague) or to a social context (e.g., a message to friends or family). In some implementations, the second GM 117 can be an LM that has been trained to generate output in a writing or speaking style of a user, and the user's writing or speaking style may differ between a work context and a social context. The second GM 117 may use the contextual information to generate output in a style that is more appropriate for the present context. Additionally, or alternatively, in some implementations, a plurality of second GMs 117 may be provided, each of which has been trained to generate output appropriate for a particular context. In some such implementations, the first GM 131 may use contextual information associated with the input 210 to select an appropriate one of the second GMs according to the present context, to generate information for adapting the provisional output that is better suited to the present context.

At block 306 of FIG. 3, the system (e.g., the second GM 117) provides the information for adapting the provisional output for processing by the first GM 131 to generate adapted output. In some implementations, in dependence on the information for adapting the provisional output indicating that at least one token among the one or more first tokens is accepted, said at least one token is included in the adapted output.

In some implementations, the second GM 117 is configured to use a different tokenization scheme to the first GM 131. In some of those implementations, providing at least part of the provisional output includes providing a complete sequence (e.g., a sequence having a length equal to or less than a threshold) decoded by the first GM 131 for processing by the second GM 117. For instance, the first GM 131 can decode a complete sequence which is then accepted or rejected, and/or re-scored or re-ranked, by the second GM 117. whenever the sequence reaches a certain length. By providing the second GM 117 with a complete sequence decoded by the first GM 131, as opposed to providing separate tokens, the need for the first and second GMs 131, 117 to have matching token vocabularies can be avoided.

Turning now to FIG. 4, a flowchart illustrating an example of the method of FIG. 3, in an implementation in which the first GM and the second GM are executed at separate devices, is depicted. For instance, in some implementations the first GM is executed on a first device, such as a server (e.g., a server-based implementation of the GM-based response system 120 of FIG. 1), and the second GM is executed on a second device, such as a user device (e.g., the client device of FIG. 1). The method illustrated in FIG. 4 can correspond to a method performed at the first device (e.g., a method performed by the GM-based response system 120 of FIG. 1).

For convenience, the operations of the method 400 are described with reference to a system that performs the operations. This system of the method 400 includes at least one processor, memory, and/or other component(s) of computing device(s) (e.g., the client device 110 of FIG. 1, generative model-based response system 120 of FIG. 1, computing device 810 of FIG. 8, and/or other computing device.). Moreover, while operations of the method 400 are shown in a particular order, this is not meant to be limiting. One or more operations may be reordered, omitted, and/or added.

In FIG. 4, blocks 302 and 306 may correspond to blocks 302 and 306 of FIG. 3. For instance, blocks 302 and 306 may respectively include some or all of the aspects described above in relation to blocks 302 and 306 of FIG. 3. Hence, for the sake of brevity a detailed description of blocks 302 and 306 will not be repeated here.

At block 404 of FIG. 4, after provisional output has been generated by the first GM 131 (e.g., at a first device) in block 302, in response to determining that the provisional output includes an instruction to adapt at least part of the provisional output the system (e.g., the first device) provides at least part of the provisional output for processing by the second GM 117 to generate information for adapting the provisional output. For instance, providing at least part of the provisional output for processing by the second GM 117 in block 404 may include transmitting at least part of the provisional output from the first device to the second device, e.g. from the GM-based response system 120 to the client device 110 over network 199 in FIG. 1.

At block 405 of FIG. 4, the system (e.g., the first device) receives the information for adapting the provisional output, e.g. by receiving the information from the second device. Then, in block 306 the system (e.g., the first device) processes the information for adapting the provisional output, using the first GM 131, to generate adapted output.

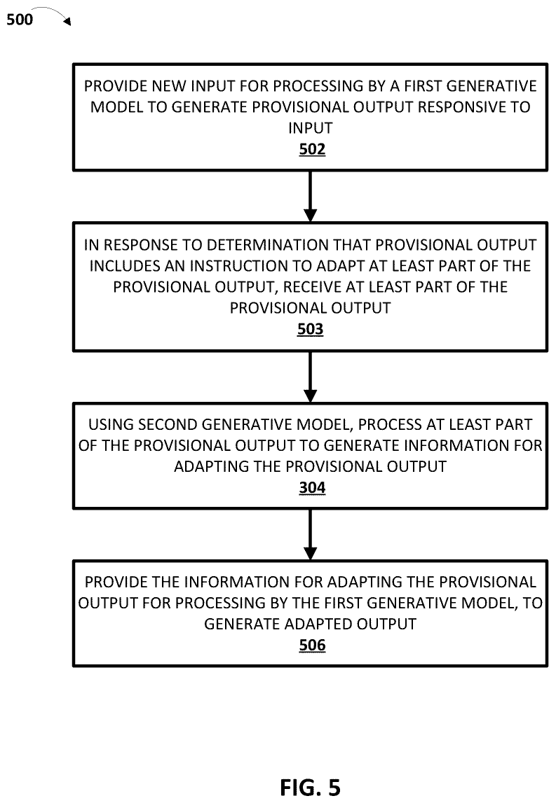

Turning now to FIG. 5, a flowchart illustrating an example of the method of FIG. 3, in an implementation in which the first GM and the second GM are executed at separate devices, is depicted. For instance, as described above with reference to FIG. 4, in some implementations the first GM is executed on a first device, such as a server (e.g., a server-based implementation of the GM-based response system 120 of FIG. 1), and the second GM is executed on a second device, such as a user device (e.g., the client device of FIG. 1). The method illustrated in FIG. 5 can correspond to a method performed at the second device (e.g., a method performed by the client device 110 of FIG. 1).

At block 502 of FIG. 5, the system (e.g., the second device, such as the client device 110 of FIG. 1) provides input for processing by a first GM 131 to generate provisional output responsive to said input. For instance, providing the input for processing by the first GM 131 in block 502 may include transmitting the input from the second device to the first device, e.g. from the client device 110 to the GM-based response system 120 over network 199 in FIG. 1.

At block 503 of FIG. 5, in response to determining that the provisional output includes an instruction to adapt at least part of the provisional output, the system (e.g., the second device, such as the client device 110 of FIG. 1) receives said at least part of the provisional output.

At block 304 of FIG. 5, the system (e.g., the second device, such as the client device 110 of FIG. 1) processes at least part of the provisional output, using the second GM 117, to generate information for adapting the provisional output. Here, block 304 may include some or all of the aspects described above in relation to block 304 of FIG. 3. Hence, for the sake of brevity a detailed description of block 304 will not be repeated here.

At block 506 of FIG. 5, the system (e.g., the second device, such as the client device 110 of FIG. 1) provides the information for adapting the provisional output for processing by the first generative model to generate adapted output. For instance, providing the information for adapting the provisional output for processing by the first GM 131 in block 506 may include transmitting the input from the second device to the first device, e.g. from the client device 110 to the GM-based response system 120 over network 199 in FIG. 1.

Although the operations of the methods 400 and 500 of FIGS. 4 and 5, respectively, are described with respect to being implemented at separate devices, it should be understood that is for the sake of illustrating some techniques described herein and is not meant to be limiting. Rather, it should be understood that, in various implementations, the operations of the methods 400 and 500 of FIGS. 4 and 5, respectively, can be performed at the same device (e.g., the client device 110).

Turning now to FIG. 6, a flowchart illustrating an example token-based method of adapting an output of a first language model, according to various implementations, is depicted. The method 600 may, for instance, correspond to any of the methods described in relation to FIGS. 3 to 5. For convenience, the operations of the method 600 are described with reference to a system that performs the operations. This system of the method 600 includes one or more processors, memory, and/or other component(s) of computing device(s). Moreover, while operations of the method 600 are shown in a particular order, this is not meant to be limiting. One or more operations may be reordered, omitted, and/or added.

At block 610, the system receives input data. In some implementations, the input data can be generated based on human user input and/or generated based on output of a GM. In some implementations, the input data can be obtained from a training dataset. The input data can be of any type or configuration suitable for processing by a generative model to generate corresponding generative output.

In some implementations, the input data can be directed to a large language model. Each respective set of input data includes an input prompt, e.g., a natural language input, such as a query. The input prompt may, in some examples, be received from a user in the form of typed text. Alternatively, or additionally, the input prompt may, in some examples, be received from a user in the form of a spoken utterance, that may be converted to text using a speech-to-text process.

Each respective set of input data includes an input prompt, i.e., a natural language input, such as a query. The input prompt may, in some examples, be received from a user in the form of typed text. Alternatively, or additionally, the input prompt may, in some examples, be received from a user in the form of a spoken utterance, that may be converted to text using a speech-to-text process. The one or more generative outputs include one or more text sequences, e.g., a natural language text sequence that is responsive to the input query.

At block 611 of FIG. 6, the system uses the first generative model 131 to generate provisional output.

At block 612 of FIG. 6, the system determines whether the provisional output includes an instruction to adapt at least part of the provisional output. For instance, the instruction to adapt at least part of the provisional output may take the form of one or more special tokens. In the implementation illustrated in FIG. 6, the first GM 131 has been trained to generate an adaptive output start token (hereinafter referred to as a START_USER_BIASED_DECODING token) and an adaptive output end token (hereinafter referred to as an END_USER_BIASED_DECODING token) indicative of a start point and an end point, respectively, of the at least part of the provisional output that is to be adapted based on said information generated by the second generative model. In block 612, the system determines whether the instruction to adapt at least part of the provisional output includes a START_USER_BIASED_DECODING token and an END_USER_BIASED_DECODING token. The first GM 117 can decode the START_USER_BIASED_DECODING token and the END_USER_BIASED_DECODING when decoding generative output responsive to new input. The START_USER_BIASED_DECODING token and the END_USER_BIASED_DECODING are indicative of the start point and end point, respectively of a part of the provisional output (e.g., a part of a sequence decoded by the first GM 131) that is to be adapted.

In block 612, the system determines whether the provisional output includes an instruction to adapt at least part of the provisional output (e.g., whether the provisional output includes at least one START_USER_BIASED_DECODING token). If so, the system proceeds to block 613. If not, the system proceeds back to block 611.

At block 613 of FIG. 6, the system provides at least part of the provisional output for processing by the second GM 117. For instance, in some implementations where the first GM 131 and the second GM 117 are executed at separate devices (e.g., a first device and a second device respectively), block 613 may involve transmitting the part of the provisional output from the first device to the second device.

At block 614 of FIG. 6, the system uses the second GM 117 to process at least part of the provisional output to generate information for adapting the provisional output.

At block 615 of FIG. 6, the system determines whether the first GM 131 has decoded the END_USER_BIASED_DECODING token. If so, the system proceeds to block 616. If not, the system proceeds back to block 613.

At block 616 of FIG. 6, the system determines whether the first GM 131 has finished decoding the generative output (e.g., the provisional output) responsive to the input that was received in block 610. If so, the system proceeds to block 617. If not, the system proceeds back to block 611.

At block 617 of FIG. 6, the system (e.g., the first GM 131) generates adapted output based on the provisional output generated by the first GM 131, and based on the information for adapting the provisional output generated by the second GM 117. In some implementations, the system may include a block (not shown) in which the information for adapting the provisional output is provided for processing by the first GM 131 (e.g. by transmitting the information for adapting the provisional output from the second device to the first device).

Turning now to FIG. 7, a flowchart illustrating an example token-based method of adapting an output of a first language model, in which a second language model can generate an end-of-sequence token to cause a sequence in the adapted output to be terminated, according to various implementations, is depicted.

In FIG. 7, blocks 610 to 617 may correspond to blocks 610 to 617 of FIG. 6. For instance, blocks 610 to 617 may respectively include some or all of the aspects described above in relation to blocks 610 to 617 of FIG. 3. Hence, for the sake of brevity a detailed description of blocks 610 to 617 will not be repeated here.

The method illustrated in FIG. 7 differs from the method illustrated in FIG. 6 in that the method of FIG. 7 includes block 718, in which the system determines whether the second GM 117 has generated an end of sequence (EOS) token (e.g., whether the second GM 117 has decoded an EOS token when processing at least part of the provisional output generated by the first GM 131). If so, the system proceeds to block 616. If not, the system proceeds to block 615. In this way, a sequence in the adapted output can be terminated under the control of the second GM 117. By enabling (e.g., training) the second GM 117 to generate an EOS token while processing at least part of the provisional output, the second GM 117 can cause a length of a sequence to be shortened in the adapted output in comparison to a corresponding sequence in the provisional output.

For instance, assume that the second GM 117 is a user LM that has been trained to generate output in a writing or speaking style of a certain user. It can be the case that the user would typically write or speak in shorter sequences (e.g., shorter sentences) compared to the style in which the first GM 131 (e.g., an automated assistant LLM) has been trained to generate output. In such cases, in some implementations the second GM 117 can be configured (e.g., trained) to decode the EOS token, thereby causing the length of a sequence in the adapted output to be shortened in comparison to a corresponding sequence in the provisional output. This can have the effect of reducing the amount of computing resources (e.g., processor runtime, memory usage etc.) required to generate the adapted output, and/or reducing the amount of computing resources required when taking further actions based on the adapted output (e.g., transmitting a message comprising the adapted output, or rendering the adapted output).

Although the operations of the methods 600 and 700 of FIGS. 6 and 7, respectively, are described with respect to certain operations being executed at separate devices, it should be understood that is for the sake of illustrating some techniques described herein and is not meant to be limiting. Rather, it should be understood that, in various implementations, the operations of the methods 600 and 700 of FIGS. 6 and 7, respectively, can be performed at the same device (e.g., the client device 110).

Turning now to FIG. 8, a block diagram of an example computing device 810 that may optionally be utilized to perform one or more aspects of techniques described herein is depicted. In some implementations, one or more of a client device, cloud-based automated assistant component(s), and/or other component(s) may include one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some, or all, of the modules described herein. For example, the storage subsystem 824 may include the logic to perform selected aspects of the methods disclosed herein, as well as to implement various components depicted in FIG. 1.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided, and includes: providing input to a first language model to generate provisional output responsive to said input, the first language model being a large language model (LLM); providing at least part of the provisional output as input to a second language model to generate information for adapting the provisional output; and providing the information for adapting the provisional output to the first language model to generate adapted output.

These and other implementations of technology disclosed herein can optionally include one or more of the following features.

In some implementations, the first language model and the second language model can be configured to use the same tokenization scheme. In some versions of those implementations, the provisional output can include a plurality of first tokens decoded by the first language model.

In some further versions of those implementations, the information for adapting the provisional output can be indicative of whether each of the one or more first tokens is accepted or rejected. In some yet further versions of those implementations, in dependence on the information for adapting the provisional output indicating that at least one token among the one or more first tokens is accepted, said at least one token can be included in the adapted output. In some additional or alternative yet further versions of those implementations, for each of the one or more first tokens that is indicated as rejected in the information for adapting the provisional output, said information can further include one or more second tokens to replace respective rejected tokens among the one or more first tokens, the second tokens may have been decoded by the second language model.

In additional or alternative further versions of those implementations, the adaptation information can be indicative of a new score and/or ranking assigned to at least one of the one or more first tokens by the second language model. In additional or alternative further versions of those implementations, said one or more first tokens can include top-k tokens generated by the first language model.

In some implementations, the adaptation information can include an end of sequence (EOS) token for terminating a sequence in the adapted output.

In some implementations, the second language model can be configured to use a different tokenization scheme to the first language model. Providing said information indicative of at least part of the provisional output can include providing a complete sequence decoded by the first language model as said input to the second language model.

In some implementations, the first language model may have been trained to generate output based on a first probability distribution, and the second language model may have been trained to generate output based on a second probability distribution different from the first probability distribution. In some versions of those implementations, the second probability distribution can be indicative of a writing or speaking style associated with a user profile. In some further versions of those implementations, the second language model can be one of a plurality of second language models and the user profile can be one of a plurality of user profiles, each of the plurality of second language models being associated with a respective one of the plurality of user profiles. The method can further include selecting a respective one of the plurality of second language models as the second language model to be used to generate said information for adapting the provisional output, in dependence on the user profile associated with said respective one of the plurality of second language models, thereby to adapt the at least part of the provisional output to the writing or speaking style associated with said user profile.

In some implementations, the first language model can be trained to generate an adaptive output start token and an adaptive output end token indicative of a start point and an end point, respectively, of the at least part of the provisional output that is to be adapted based on said information generated by the second language model.

In some implementations, the first language model can be executed on a first device, and the second language model can be executed on a second device. In some versions of those implementations, the second device can be a user device and/or the first device can be a server. In other implementations, the first language model and the second language model can be executed at a same device.

In some implementations, providing information indicative of at least part of the provisional output as input to the second language model can include providing contextual information to the second language model. The contextual information can be indicative of a context associated with the input to the first language model.

In some implementations, a method implemented by processor(s) is provided and includes processing input, using a first language model, to generate provisional output responsive to said input. The first language model is a large language model (LLM). The method further includes providing at least part of the provisional output to a second language model to generate information for adapting the provisional output; receiving the information for adapting the provisional output; and processing the information for adapting the provisional output, using the first language model, to generate adapted output.

In some implementations, a method implemented by processor(s) is provided and includes providing input to a first language model to generate provisional output responsive to said input. The first language model is a large language model (LLM). The method further includes receiving at least part of the provisional output; processing the at least part of the provisional output, using a second language model, to generate information for adapting the provisional output; and providing the information for adapting the provisional output to the first language model to generate adapted output.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A computer-implemented method of adapting output generated by a first generative model, the method comprising:
providing input for processing by the first generative model to generate provisional output responsive to said input;
in response to determining that the provisional output includes an instruction to adapt at least part of the provisional output, providing said at least part of the provisional output for processing by a second generative model to generate information for adapting the provisional output; and
providing the information for adapting the provisional output for processing by the first generative model to generate adapted output.

2. The method of claim 1, wherein the first generative model and the second generative model are configured to use the same tokenization scheme.

3. The method of claim 2, wherein the provisional output comprises a plurality of first tokens decoded by the first generative model.

4. The method of claim 3, wherein the information for adapting the provisional output is indicative of whether each of the one or more first tokens is accepted or rejected.

5. The method of claim 4, wherein in dependence on the information for adapting the provisional output indicating that at least one token among the one or more first tokens is accepted, said at least one token is included in the adapted output.

6. The method of claim 4, wherein for each of the one or more first tokens that is indicated as rejected in the information for adapting the provisional output, said information comprises one or more second tokens to replace respective rejected tokens among the one or more first tokens, the second tokens having been decoded by the second generative model.

7. The method of claim 3, wherein the adaptation information is indicative of a new score and/or ranking assigned to at least one of the one or more first tokens by the second generative model.

8. The method of claim 3, wherein said one or more first tokens include top-k tokens generated by the first generative model.

9. The method of claim 1, wherein the adaptation information includes an end of sequence (EOS) token to cause a sequence in the adapted output to be terminated.

10. The method of claim 1, wherein the second generative model is configured to use a different tokenization scheme to the first generative model, and wherein providing said at least part of the provisional output includes providing a complete sequence decoded by the first generative model for processing by the second generative model.

11. The method of claim 1, wherein the first generative model has been trained to generate output based on a first probability distribution, and wherein the second generative model has been trained to generate output based on a second probability distribution different from the first probability distribution.

12. The method of claim 11, wherein the second generative model is a language model (LM), and wherein the second probability distribution is indicative of a writing or speaking style associated with a user profile.

13. The method of claim 12, wherein the second generative model is one of a plurality of second generative models and the user profile is one of a plurality of user profiles, each of the plurality of second generative models being associated with a respective one of the plurality of user profiles, the method comprising:
selecting a respective one of the plurality of second generative models as the second generative model to be used to generate said information for adapting the provisional output, in dependence on the user profile associated with said respective one of the plurality of second generative models, thereby to adapt the at least part of the provisional output to the writing or speaking style associated with said user profile.

14. The method of claim 1, wherein the first generative model has been trained to generate an adaptive output start token and an adaptive output end token indicative of a start point and an end point, respectively, of the at least part of the provisional output that is to be adapted based on said information generated by the second generative model.

15. The method of claim 1, wherein the first generative model is executed on a first device, and the second generative model is executed on a second device.

16. The method of claim 15, wherein the second device is a user device and/or wherein the first device is a server.

17. The method of claim 1, wherein providing said at least part of the provisional output for processing by the second generative model comprises providing contextual information for processing by the second language model, wherein the contextual information is indicative of a context associated with the input provided to the first generative model.

18. A system comprising:
one or more processors; and
memory storing computer readable instructions that, when executed by the one or more processors, cause the one or more processors to be operable to:
provide input for processing by the first generative model to generate provisional output responsive to said input;
in response to determining that the provisional output includes an instruction to adapt at least part of the provisional output, provide said at least part of the provisional output for processing by a second generative model to generate information for adapting the provisional output; and
provide the information for adapting the provisional output for processing by the first generative model to generate adapted output.

19. A non-transitory computer readable medium containing computer-readable instructions that, when executed by a computer, cause the computer to:
provide input for processing by the first generative model to generate provisional output responsive to said input;
in response to determining that the provisional output includes an instruction to adapt at least part of the provisional output, provide said at least part of the provisional output for processing by a second generative model to generate information for adapting the provisional output; and
provide the information for adapting the provisional output for processing by the first generative model to generate adapted output.
